(19) United States
(12) Patent Application Publication
(10) Pub. No.: US 2022/0259700 A1
(43) Pub. Date: Aug. 18, 2022

(54) MAX PHASE-GOLD COMPOSITES AND METHODS FOR MAKING THE SAME

(71) Applicant: Drexel University, Philadelphia, PA (US)

(72) Inventors: Michel BARSOUM, Moorestown, NJ (US); Maxim SOKOL, Philadelphia, PA (US)

(21) Appl. No.: 17/630,717

(22) PCT Filed: Jul. 29, 2020
(86) PCT No.: PCT/US2020/044015

§ 371 Date: Jan. 27, 2022

Related U.S. Application Data
(60) Provisional application No. 62/880,306, filed on Jul. 30, 2019.

(51) Int. Cl. C22C 5/02; C22C 32/00; C22F 1/14; C22C 1/04

(52) U.S. Cl. CPC C22C 5/02; C22C 1/0466; C22F 1/14; C22C 32/0052

(57) ABSTRACT

This disclosure is directed to composites of MAX-phase materials and gold, and methods for preparing the same.

### CROSS REFERENCE TO RELATED APPLICATIONS

The present application claims priority to and the benefit of U.S. patent application No. 62/880,306, “MAX Phase-Gold Composites And Methods For Making The Same” (filed Jul. 30, 2019), the entirety of which application is incorporated herein by reference for any and all purposes.

### TECHNICAL FIELD

This disclosure is directed to the field of MAX-phase composites and methods for preparing the same.

### BACKGROUND

Gold is one of the first metals used by mankind, and occurs in native form in various parts of the earth's crust and is sufficiently ductile in this form to be shaped into jewelry and traditional utensils. The ability to refine gold and to fabricate it into any forms, its durability and imperviousness to atmospheric or chemical attack, and its relative scarcity have given gold a pre-eminent position as a monetary medium throughout recorded history.

Owing to this unique combination of properties, gold is used widely, including as medium of exchange and currency (e.g., gold bars and coins), as a ‘store of value’ for central bankers and investors, in decorative ornaments and jewelry, in dentistry (e.g., dental crowns), and as a raw material for electronic goods.

For many uses of gold, however, the pure metal is too soft on its own and must be hardened by the addition of alloying elements, copper, silver, nickel, palladium, and zinc. Apart from copper, all other alloying metals to gold tend to whiten the color, and so it is possible to make karat golds that are white in color. While white gold is popular in the jewelry industry, many are allergic to nickel contacting their skin, which gives rise to a red skin rash or irritation.

European Union countries have enacted legislation that limits nickel release from jewelry. Thus, in Europe, nickel white golds are being phased out and being replaced by palladium white golds, and Japan and China have taken a similar position on nickel. The United States has taken a more relaxed approach, requiring jewelry to be labelled as nickel-containing, and much jewelry is now advertised as being ‘non-allergenic’ or ‘nickel-free’. Thus, the technology of white golds is particularly relevant in today's market scenario. Accordingly, there is a long-felt need in the art for gold-containing materials that are machinable but are free of other allergy-causing materials.

### SUMMARY

In meeting the disclosed long-felt needs, the present disclosure provides a composite composition, comprising gold and one or more MAX-phase materials.

Also provided are articles, comprising a composite composition according to the present disclosure.

Further provided are methods, comprising operating an article according to the present disclosure.

Additionally provided are methods, comprising compacting and thermally treating gold and at least one MAX-phase material so as to give rise to a composite composition according to the present disclosure.

Further provided are methods, comprising forming a workpiece from a composite composition according to the present disclosure.

The MAX or Mₙ₊₁AXₙ phases are layered, hexagonal, early transition-metal carbides and nitrides, where n=1, 2, or 3, “M” is an early transition metal, “A” is an A-group (mostly groups 13 and 14) element, and “X” is C and/or N. Those materials combine some of the more attractive properties of metals (machinability), good thermal and electric conductors, excellent thermal shock resistance and damage tolerance) and ceramics (high melting points, lightweight, stiff and creep, oxidation, and fatigue resistant). Alumina forming MAX phases are also oxidation resistant (up to 1400° C.), as they can form a slow growing protective alumina (Al₂O₃) layer.

### BRIEF DESCRIPTION OF THE DRAWINGS

The present application is further understood when read in conjunction with the included drawings. For illustrating the subject matter, there are shown in the drawings exemplary embodiments of the subject matter; however, the presently disclosed subject matter is not limited to the specific methods, devices, and systems disclosed. In addition, the drawings are not necessarily drawn to scale.

FIGS. 1A-1C illustrate indicative crystal structures of the MAX phases in which the transitional metal carbide or nitride (Mₙ₊₁Xₙ) layers are interleaved with layers of pure A-group element. FIG. 1A illustrates the configuration of the M₂X framework within the 211 class of MAX phase compounds, wherein every third layer is A-group. FIG. 1B illustrates the configuration of the M₃X₂ framework within the 312 class of MAX phase compounds, wherein every fourth layer is A-group. FIG. 1C illustrates the configuration of the M₄X₃ framework within the 413 class of MAX phase compounds, wherein every fifth layer is A-group.

FIGS. 2A-2B provide a 3-dimensional (FIG. 2A) and 2-dimensional (FIG. 2B) representation of the crystal structure of the 312 class of compounds.

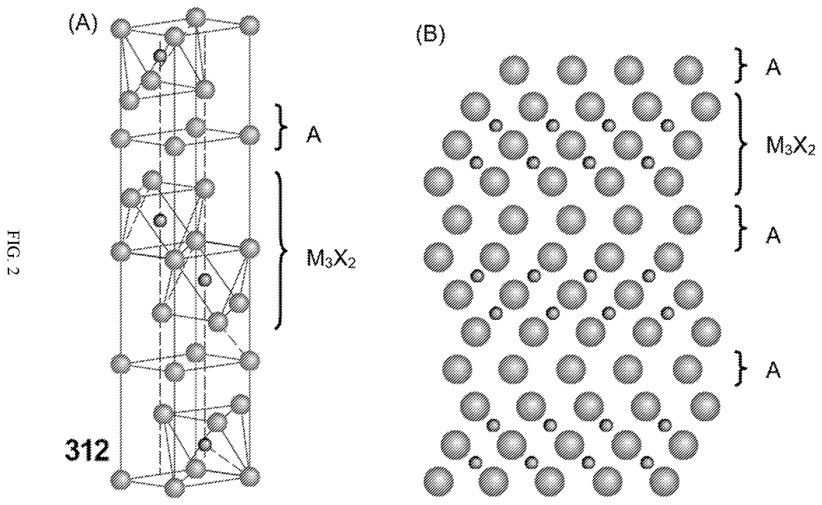

FIG. 3 provides XRD patterns of various example as-synthesized MAX powders.

FIG. 4 provides images of as-fabricated surfaces and polished cross sections of various Au/MAX composites.

FIG. 5 provides exemplary BSE SEM micrographs of Au/Ti₃SiC₂ (left) and Au/Ta₂AlC (right).

FIG. 6 provides exemplary XRD patterns of Au/MAX composites.

FIG. 7 provides SEM images of Vickers imprints on Au/Ti₃SiC (left) and Au/Ta₂AlC (right) composite materials.

### DETAILED DESCRIPTION OF ILLUSTRATIVE EMBODIMENTS

The present disclosure may be understood more readily by reference to the following description taken in connection with the accompanying Figures and Examples, all of which form a part of this disclosure. It is to be understood that this disclosure is not limited to the specific products, methods, conditions or parameters described or shown herein, and that the terminology used herein is for the purpose of describing particular embodiments by way of example only and is not intended to be limiting of any claimed invention. Similarly, unless specifically otherwise stated, any description as to a possible mechanism or mode of action or reason for improvement is meant to be illustrative only, and the disclosure herein is not to be constrained by the correctness or incorrectness of any such suggested mechanism or mode of action or reason for improvement. Throughout this text, it is recognized that the descriptions refer to compositions and methods of making and using said compositions. That is, where the disclosure describes or claims a feature or embodiment associated with a composition or a method of making or using a composition, it is appreciated that such a description or claim is intended to extend these features or embodiment to embodiments in each of these contexts (i.e., compositions, methods of making, and methods of using).

### Terms

In the present disclosure the singular forms “a,” “an,” and “the” include the plural reference, and reference to a particular numerical value includes at least that particular value, unless the context clearly indicates otherwise. Thus, for example, a reference to “a material” is a reference to at least one of such materials and equivalents thereof known to those skilled in the art, and so forth.

When a value is expressed as an approximation by use of the descriptor “about,” it will be understood that the particular value forms another embodiment. In general, use of the term “about” indicates approximations that can vary depending on the desired properties sought by the disclosed subject matter and is to be interpreted in the specific context in which it is used, based on its function. The person skilled in the art will be able to interpret this as a matter of routine. In some cases, the number of significant figures used for a particular value may be one non-limiting method of determining the extent of the word “about.” In other cases, the gradations used in a series of values may be used to determine the intended range available to the term “about” for each value. Where present, all ranges are inclusive and combinable. That is, references to values stated in ranges include every value within that range.

It is to be appreciated that certain features of the disclosure which are, for clarity, described herein in the context of separate embodiments, may also be provided in combination in a single embodiment. That is, unless obviously incompatible or specifically excluded, each individual embodiment is deemed to be combinable with any other embodiment(s) and such a combination is considered to be another embodiment. Conversely, various features of the disclosure that are, for brevity, described in the context of a single embodiment, may also be provided separately or in any sub-combination. Finally, while an embodiment may be described as part of a series of steps or part of a more general structure, each said step may also be considered an independent embodiment in itself, combinable with others.

When a list is presented, unless stated otherwise, it is to be understood that each individual element of that list, and every combination of that list, is a separate embodiment. For example, a list of embodiments presented as “A, B, or C” is to be interpreted as including the embodiments, “A,” “B,” “C,” “A or B,” “A or C,” “B or C,” or “A, B, or C.”

The transitional terms “comprising,” “consisting essentially of,” and “consisting” are intended to connote their generally in accepted meanings in the patent vernacular; that is, (i) “comprising,” which is synonymous with “including,” “containing,” or “characterized by,” is inclusive or open-ended and does not exclude additional, unrecited elements or method steps; (ii) “consisting of” excludes any element, step, or ingredient not specified in the claim; and (iii) “consisting essentially of” limits the scope of a claim to the specified materials or steps “and those that do not materially affect the basic and novel characteristic(s)” of the claimed disclosure. Embodiments described in terms of the phrase “comprising” (or its equivalents), also provide, as embodiments, those which are independently described in terms of “consisting of” and “consisting essentially of.” Where the term “consisting essentially of” is used, the basic and novel characteristic(s) of the method is intended to be the ability of the MAX phase materials to strengthen the hardness of Au.

MAX-phase materials are well known in the art as materials having an empirical formula Mₙ₊₁AXₙ. wherein M is at least one Group IIIB, IVB, VB, or VIB metal (including, but not limited to, chromium, hafnium, molybdenum, niobium, scandium, tantalum, titanium, vanadium, and zirconium), wherein A is an A-group element (including, but not limited to, Al, As, Cd, Ga, Ge, In, P, S, Si, Sn, Tl); each X is C and/or N (i.e., stoichiometrically X═CₓN_{y}, including where x+y=1); and n=1, 2, or 3.

In some embodiments, the terms “M” or “M atoms,” “M elements,” or “M metals” refers to one or more members of the Groups IIIB, IVB, VB, or VIB or (aka) Groups 3-6 of the periodic table, either alone or in combination, said members including Sc, Y, Lu, Ti, Zr, Hf, V, Nb, Ta, Cr, Mo, and W. In preferred embodiments, the transition metal is one or more of Sc, Ti, Zr, Hf, V, Nb, Ta, Cr, and/or Mo. In other preferred embodiments, the transition metal is one or more of Ti, Zr, V, Cr, Nb, and/or Ta. In even more preferred embodiments, the transition metal is Ti, Ta, V, and/or Cr.

MAX phase compositions are generally recognized as comprising layered, hexagonal carbides and nitrides have the general formula: Mₙ₊₁AXₙ, (MAX) where n=1 to 3, in which M is typically described as an early transition metal (comprising a Group IIIB, IVB, VB, or VIB metal), A is described as an A-group (mostly IIIA and IVA, or groups 13 and 14) element and X is either carbon and/or nitrogen. See, e.g., M. W. Barsoum, et al., “Synthesis and Characterization of a Remarkable Ceramic: Ti₃SiC₂,” J. Amer. Ceramics. Soc., 79, 1953-1956 (1996); M. W. Barsoum, “The M_{N+1}AX_{N} Phases: A New Class of Solids: Thermodynamically Stable Nanolaminates,” Progress in Solid State Chemistry, 28, 201-281 (2000), both of which are incorporated by reference herein. Additional references teaching MAX-phase materials, and their properties are discussed in:
M. W. Barsoum and T. El-Raghy, J. Am. Ceram. Soc. 79, 1953 (1996);
M. W. Barsoum, Prog. Solid State Chem. 28, 201 (2000);
M. W. Barsoum, MAX Phases: Properties of Machinable Ternary Carbides and Nitrides (Wiley-VCH, 2013);
M. Sokol, V. Natu, S. Kota, and M. W. Barsoum, Trends Chem. xx, 1 (2019);
M. Barsoum and T. El-Raghy, Am. Sci. 89, 334 (2001);
X. H. Wang and Y. C. Zhou, J Mater. Sci. Technol. 26, 385 (2010);
D. J. Tallman, M. Naguib, B. Anasori, and M. W. Barsoum, Scr. Mater. 66, 805 (2012);
M. Radovic, M. W. Barsoum, T. El-Raghy, and S. M. Wiederhorn, J. Alloys Compd. 361, 299 (2003);
M. Radovic, M., Barsoum, T. El-Raghy, and S. Wiederhorn, Acta Mater. 49, 4103 (2001);
T. Zhen, M. W. Barsoum, S. R. Kalidindi, M. Radovic, Z. M. Sun, and T. El-Raghy, Acta Mater. 53, 4963 (2005);
S. Li, X. Chen, Y. Zhou, and G. Song, Ceram. Int. 39, 2715 (2013);
M. W. Barsoum, T. El-Raghy, and L. U. J. T. Ogbuji, J. Electrochem. Soc. 144, 2508 (1997);
M. Sundberg, G. Malmqvist, A. Magnusson, and T. El-Raghy, Ceram. Int. 30, 1899 (2004); and
S. Li, G. Song, K. Kwakernaak, S. van der Zwaag, and W. G. Sloof, J Eur. Ceram. Soc. 32, 1813 (2012). Each of the foregoing is incorporated herein by reference in its entirety, at least for its teaching of MAX-phase materials and its properties.

While Ti₃AlC₂ is among the most widely studied of these materials, more than 60 MAX phases are currently known to exist and are useful in the present invention. While not intending to be limiting, representative examples of MAX phase materials useful in the present invention include: (211) Ti₂CdC, Sc₂InC, Ti₂AlC, Ti₂GaC, Ti₂InC, Ti₂TlC, V₂AlC, V₂GaC, Cr₂GaC, Ti₂AlN, Ti₂GaN, Ti₂InN, V₂GaN, Cr₂GaN, Ti₂GeC, Ti₂SnC, Ti₂PbC, V₂GeC, Cr₂AlC, Cr₂GeC, V₂PC, V₂AsC, Ti₂SC, Zr₂InC, Zr₂TlC, Nb₂AlC, Nb₂GaC, Nb₂InC, Mo₂GaC, Zr₂InN, Zr₂TlN, Zr₂SnC, Zr₂PbC, Nb₂SnC, Nb₂PC, Nb₂AsC, Zr₂SC, Nb₂SC, Hf₂InC, Hf₂TlC, Ta₂AlC, Ta₂GaC, Hf₂SnC, Hf₂PbC, Hf₂SnN, Hf₂SC; (312) Ti₃AlC₂, V₃AlC₂, Ti₃SiC₂, Ti₃GeC₂, Ti₃SnC₂, Ta₃AlC₂, and (413) Ti₄AlN₃, V₄AlC₃, Ti₄GaC₃, Ti₄SiC₃, Ti₄GeC₃, Nb₄AlC₃, and Ta₄AlC₃. Solid solutions of these materials can also be used as described herein.

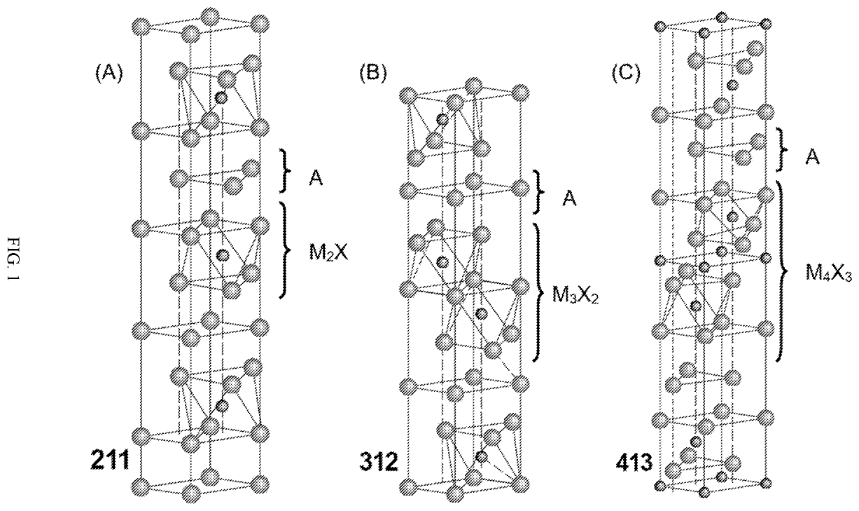

MAX phase materials are themselves known to exist as laminated structures with anisotropic properties. These materials are layered hexagonal (space group P63/mmc), with two formula units per unit cell (FIG. 1). Near close-packed M-layers are interleaved with pure A-group element layers, with the X-atoms filling the octahedral sites between the former.

The term “MXene” refers to a two-dimensional crystalline phase in which the A element of the corresponding MAX phase is removed or absent.

### EXAMPLES

The Examples described herein are provided to illustrate some of the concepts described within this disclosure. While each Example is considered to provide specific individual embodiments of composition, methods of preparation and use, none of the Examples should be considered to limit the more general embodiments described herein. In particular, while the examples provided here focus on specific MXene materials, it is believed that the principles described are relevant to other such MXene materials. Accordingly, the descriptions provided here should not be construed to limit the disclosure, and the reader is advised to look to the nature of the claims as a broader description.

In the following examples, efforts have been made to ensure accuracy with respect to numbers used (e.g. amounts, temperature, etc.) but some experimental error and deviation should be accounted for. Unless indicated otherwise, temperature is in degrees C., pressure is at or near atmospheric.

Ti₃AlC₂ powders were synthesized by mixing titanium carbide (TiC, Alfa Aesar, 99.5%, 2 μm), aluminum (Alfa Aesar, 99.5%, 325 mesh), and titanium (Alfa Aesar, 99.5%, 325 mesh) powders in a molar ratio of 2:1.05:1, respectively. The Ti₃SiC₂ powders were synthesized by mixing titanium carbide (TiC, Alfa Aesar, 99.5%, 2 μm), Si (99.5%, Alfa Aesar, 325 mesh), and Ti (99%, Alfa Aesar, 325 mesh) powders in a molar ratio of 1:1:1.05, respectively. The Ta₂AlC powders were synthesized by mixing tantalum (Alfa Aesar, 99.5%, 2 μm), aluminium (Alfa Aesar, 99.5%, 325 mesh), and graphite (Alfa Aesar, 99%, 325 mesh) powders in a molar ratio of 2:1.4:1, respectively. The mixed Ti₃AlC₂, Ti₃SiC₂ and Ta₂AlC powders were ball milled at 100 rpm for 24 h in a polyethylene jar using zirconia milling balls, and then heated under argon (Ar) flow for 2 h at 1350, 1450 and 1550° C., respectively. The heating and cooling rates were set at 5° C./min. The resulting loosely sintered blocks were ground using a milling bit on a drill press. The milled powders were passed through a 325-mesh (particle size <44 μm) sieve for further experiments.

The synthesized Ti₃AlC₂, Ti₃SiC₂ and Ta₂AlC MAX powders were mixed with Au powders provided by Varinor (Delémont, Switzerland) in a weight ratio of 1:3 that corresponds to gold fineness of 18 karat. The mixed powders were ball milled at 100 rpm for 24 h in a polyethylene jar using zirconia milling balls. Finally, the ball milled powders were loaded into a 1-inch circular graphite die, prepressed under uniaxial pressure of about 5 MPa and then heated under vacuum of <10 Pa for 15 min at 1080° C. in a graphite element hot press. The heating and cooling rates were set at 400° C./h.

After cooling down, the samples were cleaned by metal brush and cross-sectioned, mounted, ground and polished up to 3-micron surface quality. The microstructure was examined by a scanning electron microscope (SEM, FEI Zeiss Supra 50VP, Jena, Germany) equipped with an energy-dispersive X-ray spectroscope (EDS, Oxford INCA X-Sight 7573, Abingdon, England). X-ray diffraction (XRD) patterns of the as synthesized MAX powders and of the Gold/MAX composites were obtained using a diffractometer (Rigaku SmartLab, Tokyo, Japan) with a 2 or 5 mm slit, depending on sample size. The scans were conducted over the range of 5 to 70° 2θ, with a step size of 0.02° and a dwell time of 0.5 s per step. The Vickers hardness was determined as an average of 10 indentations performed under 2000 g using a Riehle hardness testing machine.

Results

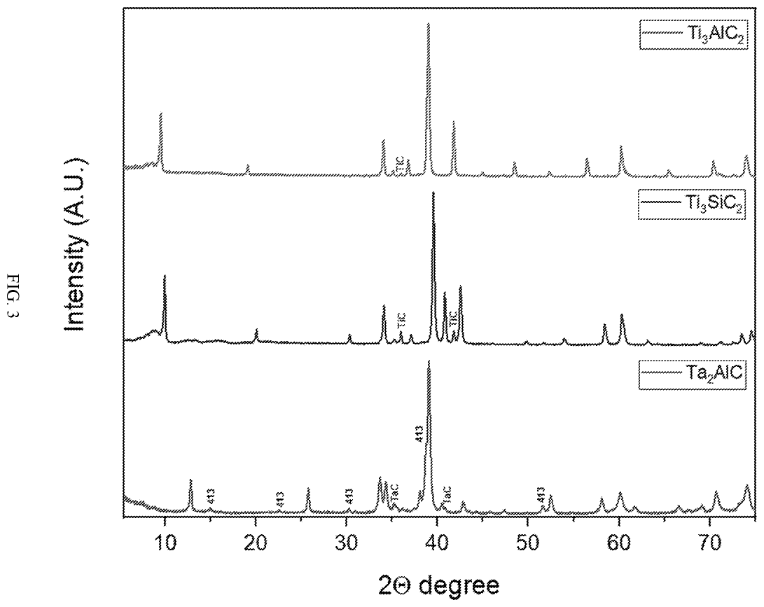

According to the results of the XRD analysis of synthesized MAX powders, presented in FIG. 3 the Ti₃AlC₂ and Ti₃SiC₂ powders had about 1 and 3 wt. % of TiC impurities, respectively. In the Ta₂AlC powders the main impurities were found to be 3 wt. % of Ta₄AlC₂ and 2 wt. % of TaC.

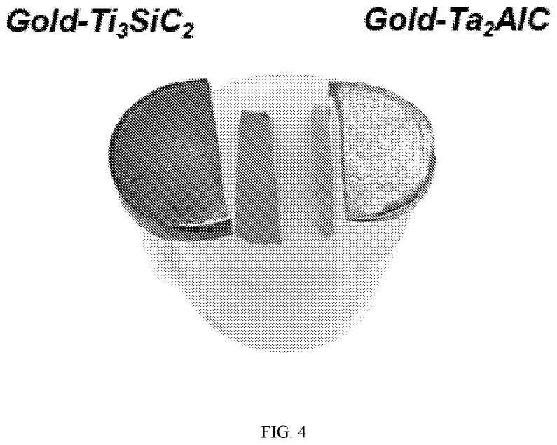

FIG. 4 shows both as-fabricated surfaces and polished cross-sections of the various Au/MAX composites. It is important to point out the variation in colors achieved by different MAX compositions. The colors of Au/Ti₃AlC₂ and Au/Ti₃SiC₂ composites were reminiscent of rhodium and platinum, respectively. In the Au/Ta₂AlC composite, the color looked more like a classic “yellow” 18-Karat Gold. We note in passing that the reported colors here are based on personal perception and not on a precise spectrophotocolorimetry measurements.

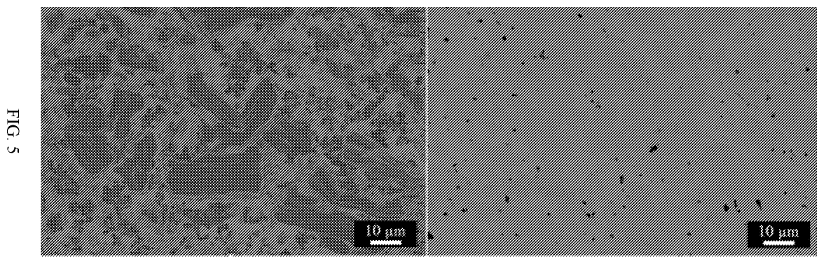

Typical backscatter electron, BSE, SEM micrographs of Au/Ti₃SiC₂ and Au/Ta₂AlC composites after polishing are shown in FIG. 5 (left and right panels, respectively). Without being bound to any particular theory, it may be that Au wets and penetrates the thin cracks and delamination of individual MAX phases and goes in between the carbide layers, perhaps by bidirectional diffusion between Au and the A-element.

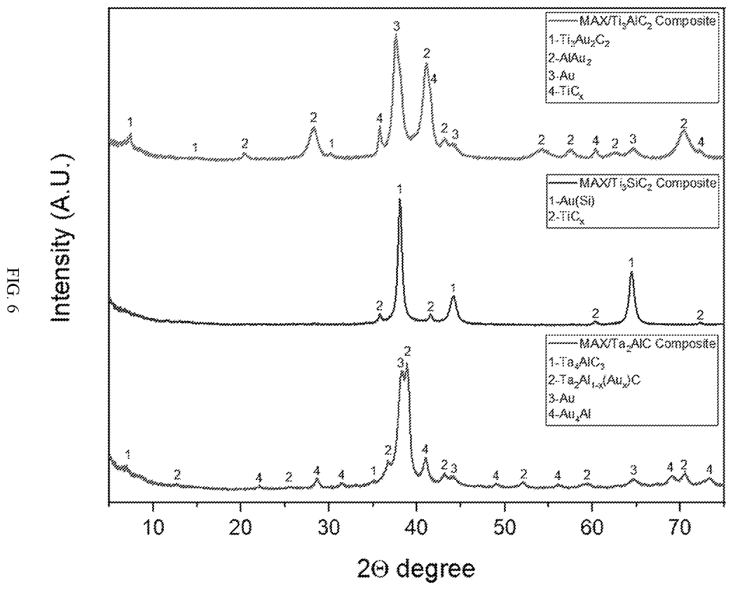

XRD patterns of the various Au/MAX composites are presented in FIG. 6. For the Au/Ti₃AlC₂ composite 4 different phases were identified in the XRD patters: Ti₃Au₂C₂, AlAu₂, Au and TiC. In the present study, Al were completely substituted by gold and no signs of Ti₃AlC₂ was detected. In the present study because of the high Au to Ti₃SiC₂ mass ratio (3:1) and full solubility of Si in Au, full dissolution of the Si were observed, though this is not a requirement or a certainty. As a result, only 2 phases were observed after the heat treatment: TiCₓ and a Au(Si) solid solution. Three main phases were observed in the Au/Ta₂AlC composite: Ta₂Al₁₋ₓ(Auₓ)C, Au and Au₄Al intermetallic. From the present results, one may suggest that the following reactions take place:

Gold/Ti₃AlC₂: Ti₃AlC₂+4Au→Ti₃Au₂C₂+AlAu₂

Gold/Ti₃SiC₂: Ti₃SiC₂+Au→Au(Si)_{SS}+Ti₃C₂

Gold/Ta₂AlC: Ta₂AlC+5xAu→Ta₂Al₁₋ₓ(Auₓ)C+xAu₄Al

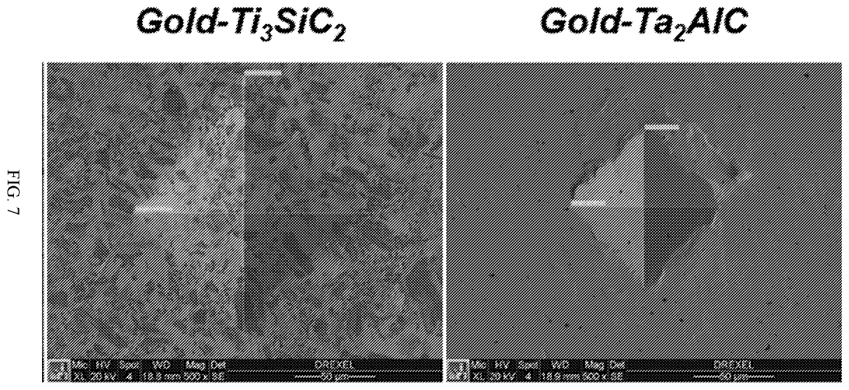

Typical SEM images of the obtained imprints after Vickers indentations are presented in FIG. 7. Average hardness values for Au/Ti₃SiC₂ and Au/Ta₂AlC composites were found to be 1.54±0.13 and 3.95±0.24 GPa, respectively. This is an order of magnitude of improvement when compared to “classic” 18 Karat gold. See M. Grimwade, Interdiscip. Sci. Rev. 17, 371 (1992), which is incorporated by reference for all teachings, or at least for its teaching of gold hardness.

The following Aspects are illustrative only and do not serve to limit the scope of the present disclosure or of the appended claims

Aspect 1. A composite composition, comprising gold and one or more MAX-phase materials. The composition can be present as, e.g., pellets, ingots, or other solid bodies. The composition can also be present as flakes or even in particulate form. The composition can be present in solid form, but can also be present in a porous form.

Aspect 2. The composite composition of Aspect 1, wherein the gold is present in excess by weight of the one or more MAX-phase materials. Relative to the total weight of the composite composition, the gold can be present at, e.g., from about 50% to about 99.9%, from about 55% to about 97%, from about 58% to about 92%, from about 62% to about 88%, from about 65% to about 85%, from about 68% to about 81%, or even from about 71% to about 77%, and all intermediate values. Gold can also be present at less than half of the total weight of the composite composition, e.g., from 49% to about 0.1%, from about 45% to about 0.5%, from about 41% to about 1%, from about 38% to about 5%, from about 33% to about 11%, from about 29% to about 14%, from about 22% to about 15%, and all intermediate values.

Aspect 3. The composite composition of any one of Aspects 1-2, wherein the one or more MAX-phase materials comprise a stoichiometry of Mₙ₊₁AXₙ;

a. wherein M is at least one Group IIIB, IVB, VB, or VIB metal (including, but not limited to, chromium, hafnium, molybdenum, niobium, scandium, tantalum, titanium, vanadium, and zirconium)

b. wherein A is an A-group element (including, but not limited to, Al, As, Cd, Ga, Ge, In, P, S, Si, Sn, Tl);

c. each X is C and/or N (i.e., stoichiometrically X═CₓN_{y}, including where x+y is about 1); and n=1, 2, or 3.

Aspect 4. The composite composition of any one of Aspects 1-3, wherein at least one of the MAX-phase materials comprise Ti₃AlC₂, Ti₃SiC₂, Ti₂SnC, Ti₂InC, or Ta₂AlC.

Aspect 5. The composite composition of any one of Aspects 1-4, comprising a phase characterized by the presence of a material in which at least some of the A element in at least one of the MAX-phase materials is replaced by Au, and having a stoichiometry of Mₙ₊₁Au_{q}A_{(1-q)}Xₙ.

Aspect 6. The composite composition of any one of Aspects 1 to 4, comprising a phase characterized by the presence of a material in the A element of the MAX-phase powder phase is completely replaced by Au, such that the composite comprises a composition of the stoichiometry Mₙ₊₁Au_{q}Xₙ;

a. wherein M is at least one Group IIIB, IVB, VB, or VIB metal (including, but not limited to, chromium, hafnium, molybdenum, niobium, scandium, tantalum, titanium, vanadium, and zirconium);

b. each X is C and/or N (i.e., stoichiometrically X═CₓN_{y}, including where x+y is about 1);

c. q is 1 or 2;

d. and n=1, 2, or 3.

Aspect 7. The composite composition of Aspects 1-7, wherein the A element is Al.

Aspect 8. The composite composition of any one of Aspects 1-4, where the A element is Si and the composite composition comprises a phase comprising gold containing dissolved Si.

Aspect 9. The composite composition of any one of Aspects 1-4, where the A element is Al and the composite composition comprises a phase comprising a mixed intermetallic compound of silicon and aluminum. The mixed intermetallic compound can be, e.g., AlAu₂ or AlAu₄.

Aspect 10. The composite composition of any one of Aspects 1-9, comprising a MXene composition, Mₙ₊₁Xₙ;

a. wherein M is at least one Group IIIB, IVB, VB, or VIB metal (including, but not limited to, chromium, hafnium, molybdenum, niobium, scandium, tantalum, titanium, vanadium, and zirconium);

b. each X is C and/or N (i.e., stoichiometrically X═CₓN_{y}, including where x+y is about 1); and n=1, 2, or 3.

Aspect 11. The composite composition of any one of Aspects 1-10, wherein the composite composition is characterized as exhibiting a Vickers hardness that is at least 5%, at least 10%, at least 50%, at least 100%, at least 500%, or at least 10 times harder than 18 Karat gold.

Aspect 12. The composite composition of any one of Aspects 1-11, wherein the composite composition exhibits a Vickers hardness of at least 0.25 GPa, at least 0.5 GPa, at least 1.5 GPa, at least 2 GPa, at least 2.5 GPA, at least 3 GPa, or at least 3.5 GPa, up to about 4 GPa, to about 4.5, or to about 5 GPa.

Aspect 13. The composite composition of any one of Aspects 1-12, wherein the composite composition's thermal conductivity, the electric conductivity, the thermal shock resistance, the resistance to oxidation, and/or fatigue resistance is at least 10%, 25%, 50%, 100%, 250%, 500%, or 1000% higher than the corresponding MAX-phase material. By “corresponding MAX-phase material” is meant a corresponding material that is identical to the gold-including composite composition, except that the corresponding material is free of gold.

Aspect 14. The composite composition of any one of Aspects 1-13, wherein the composite composition is derived from or derivable from the compaction and thermal treatment of gold and at least one MAX-phase material.

Aspect 15. The composite composition of Aspect 14, wherein the compaction of the gold and the at least one MAX-phase material is performed at a temperature above the melting temperature of gold.

Aspect 16. The composite composition of any one of Aspects 1-15, further comprising a polymer.

Aspect 17. The composite composition of Aspect 16, wherein the polymer is characterized as a matrix within which the gold and the at least one MAX-phase material are disposed.

Aspect 18. The composite composition of any one of Aspects 16-17, wherein the polymer is a synthetic polymer.

Aspect 19. The composite composition of any one of Aspects 16-17, wherein the polymer is a natural polymer.

A variety of polymers (including thermoplastics and thermosets) can be used. Polyethylenes and polypropylenes are considered suitable, as are polystyrenes, polyamides, polyanilines, polyurethanes, and the like.

Aspect 20. An article, comprising the composite composition of any one of Aspects 1-19.

Aspect 21. The article of Aspect 20, wherein the article comprises a watch or an article of jewelry. Watches can be digital or analog. Jewelry can be, e.g., a ring, an earring, a bracelet, a necklace, a pin, and the like. The article can comprise a piece of wearable technology, e.g., an activity tracker.

Aspect 22. The article of Aspect 20, wherein the article comprises an electronic device. Such an electronic device can include, e.g., a circuit board.

Aspect 23. A method, comprising operating an article according to any one of Aspects 20-22.

Aspect 24. A method, comprising compacting and thermally treating gold and at least one MAX-phase material so as to give rise to a composite composition according to any one of Aspects 1-19.

Aspect 25. The method of Aspect 23, wherein the gold is present in excess by weight of the one or more MAX-phase materials.

Aspect 26. The method of any one of Aspects 24-25, further comprising milling the gold and the at least one MAX-phase material.

Aspect 27. A method, comprising forming a workpiece from a composite composition according to any one of Aspects 1-19.

Aspect 28. The method of Aspect 27, wherein the forming comprises compacting, thermally treating, or any combination thereof.

As those skilled in the art will appreciate, numerous modifications and variations of the present invention are possible in light of these teachings, and all such are contemplated hereby.

All references cited within this specification are incorporated by reference in their entireties for all purposes, or at least for their teachings in the context of their recitation.

1. A composite composition, comprising gold and one or more MAX-phase materials.

2. The composite composition of claim 1, wherein the gold is present in excess by weight of the one or more MAX-phase materials.

3. The composite composition of claim 1, wherein the one or more MAX-phase materials comprise stoichiometry Mₙ₊₁AXₙ;
a. wherein M is at least one Group IIIB, IVB, VB, or VIB metal (including, but not limited to, chromium, hafnium, molybdenum, niobium, scandium, tantalum, titanium, vanadium, and zirconium)
b. wherein A is an A-group element (including, but not limited to, Al, As, Cd, Ga, Ge, In, P, S, Si, Sn, Tl);
c. each X is C and/or N (i.e., stoichiometrically X═CₓN_{y}, including where x+y is about 1); and n=1, 2, or 3.

4. The composite composition of claim 1, wherein at least one of the MAX-phase materials comprise Ti₃AlC₂, Ti₃SiC₂, Ti₂SnC, Ti₂InC, or Ta₂AlC.

5. The composite composition of claim 1, comprising a phase characterized by the presence of a material in which at least some of the A element in at least one of the MAX-phase materials is replaced by Au, and having a stoichiometry Mₙ₊₁Au_{q}A_{(1-q)}Xₙ.

6. The composite composition of claim 1, comprising a phase characterized by the presence of a material in the A element of the MAX-phase powder phase is completely replaced by Au, such that the composite comprises a composition of stoichiometry Mₙ₊₁Au_{q}Xₙ;
a. wherein M is at least one Group IIIB, IVB, VB, or VIB metal (including, but not limited to, chromium, hafnium, molybdenum, niobium, scandium, tantalum, titanium, vanadium, and zirconium);
b. each X is C and/or N (i.e., stoichiometrically X═CₓN_{y}, including where x+y is about 1);
c. q is 1 or 2;
d. and n=1, 2, or 3.

7. The composite composition of claim 1, wherein the A element is Al.

8. The composite composition of claim 1, where the A element is Si and the composite composition comprises a phase comprising gold containing dissolved Si.

9. The composite composition of claim 1, where the A element is Al and the composite composition comprises a phase comprising a mixed intermetallic compound of silicon and aluminum, the mixed intermetallic compound optionally comprising AlAu₂ or AlAu₄.

10. The composite composition of claim 1, comprising a MXene composition, Mₙ₊₁Xₙ;
a. wherein M is at least one Group IIIB, IVB, VB, or VIB metal (including, but not limited to, chromium, hafnium, molybdenum, niobium, scandium, tantalum, titanium, vanadium, and zirconium);
b. each X is C and/or N (i.e., stoichiometrically X═CₓN_{y}, including where x+y is about 1); and n=1, 2, or 3.

11. The composite composition of claim 1, wherein the composite composition is characterized as exhibiting a Vickers hardness that is at least 5%, at least 10%, at least 50%, at least 100%, at least 500%, or at least 10 times harder than 18 Karat gold.

12. The composite composition of claim 1, wherein the composite composition exhibits a Vickers hardness of at least 0.25 GPa, at least 0.5 GPa, at least 1.5 GPa, at least 2 GPa, at least 2.5 GPA, at least 3 GPa, or at least 3.5 GPa, to about 4 GPa, to about 4.5, or to about 5 GPa.

13. The composite composition of claim 1, wherein the composite composition's thermal conductivity, the electric conductivity, the thermal shock resistance, the resistance to oxidation, and/or fatigue resistance is at least 10%, 25%, 50%, 100%, 250%, 500%, or 1000% higher than the corresponding MAX-phase material.

14. The composite composition of claim 1, wherein the composite composition is derived from or derivable from the compaction and thermal treatment of gold and at least one MAX-phase material.

15. The composite composition of claim 14, wherein the compaction of the gold and the at least one MAX-phase material is performed at a temperature above the melting temperature of gold.

16. The composite composition of claim 1, further comprising a polymer.

17. The composite composition of claim 16, wherein the polymer is characterized as a matrix within which the gold and the at least one MAX-phase material are disposed.

18. The composite composition of claim 16, wherein the polymer is a synthetic polymer.

19. The composite composition of claim 16, wherein the polymer is a natural polymer.

20. An article, comprising the composite composition of claim 1.

21. The article of claim 20, wherein the article comprises a watch or an article of jewelry.

22. The article of claim 20, wherein the article comprises an electronic device.

23. A method, comprising operating an article according to claim 20.

24. A method, comprising compacting and thermally treating gold and at least one MAX-phase material so as to give rise to a composite composition according to claim 1.

25. The method of claim 23, wherein the gold is present in excess by weight of the one or more MAX-phase materials.

26. The method of claim 24, further comprising milling the gold and the at least one MAX-phase material.

27. A method, comprising forming a workpiece from a composite composition according to claim 1.

28. The method of claim 27, wherein the forming comprises compacting, thermally treating, or any combination thereof.
